(19) United States
(12) Patent Application Publication
(10) Pub. No.: US 2018/0010702 A1
(43) Pub. Date: Jan. 11, 2018

(54) Check Valve for a Solenoid Valve and Associated Solenoid Valve

(71) Applicant: Robert Bosch GmbH, Stuttgart (DE)

(72) Inventor: Thomas Weitze, Mt. Pleasant, SC (US)

(21) Appl. No.: 15/610,260

(22) Filed: May 31, 2017

(30) Foreign Application Priority Data
Jul. 11, 2016 (DE) 10 2016 212 561.3

(51) Int. Cl. F16K 15/18; F16J 15/32; F16K 15/14; B60T 8/36

(52) U.S. Cl. CPC F16K 15/18; F16K 15/145; F16J 15/32; B60T 8/3615

(57) ABSTRACT

A check valve for a solenoid valve inclues a check valve seat that is arranged on an edge of a fluid passage and a movable closing element configured to execute a direction-oriented throughflow and sealing function. The closing element includes a sealing cone, a contact foot with a plurality of outflow grooves formed on the edge, and an elastic sealing ring that is arranged between the contact foot and the sealing cone. The outflow grooves form in each case a seating edge for the elastic sealing ring during sealing. The outflow grooves are configured in each case with an arcuate seating edge, which has a predetermined arc length, so that a circle segment of the elastic sealing ring, with an opening angle in the region of 40° to 120°, butts against the respective seating edge during sealing. A solenoid valve includes the check valve.

This application claims priority under 35 U.S.C. § 119 to patent application no. DE 10 2016 212 561.3, filed on Jul. 11, 2016 in Germany, the disclosure of which is incorporated herein by reference in its entirety.

### BACKGROUND

The disclosure is based on a check valve for a solenoid valve. A solenoid valve for such a check valve is also the subject matter of the present disclosure.

Solenoid valves with a solenoid sub-assembly, a valve cartridge and a valve bottom part are known from the prior art, in which are formed between a fluid inlet and a fluid outlet a first fluid passage, the flow cross section of which is adjustable by a main valve, and a second fluid passage, the flow cross section of which is adjustable by means of a direction-oriented check valve. Such solenoid valves can be used for example in an anti-lock system (ABS) or an anti-slip control system (ASR system) or an electronic stability program system (ESP system).

A solenoid valve with a solenoid sub-assembly, a valve cartridge and a valve bottom part is known from DE 10 2007 042 717 A1. The valve cartridge comprises an armature, which is movably guided inside a capsule, a valve insert, a plunger which is movably guided inside the valve insert and has a closing body with a main sealing element, and a valve body with a main valve seat. Formed between a fluid inlet and a fluid outlet is a first fluid passage, the flow cross section of which is adjustable by a main valve which has the main sealing element, which is connected to the closing body, and has the main valve seat, which is arranged in the valve body, wherein a magnetic force which is created by the solenoid sub-assembly moves the armature and the plunger and immerses the main sealing element into the main valve seat with sealing effect for the execution of a sealing function. Moreover, a second fluid passage, the flow cross section of which is adjustable by means of a direction-oriented check valve, is formed in the valve bottom part between the fluid inlet and the fluid outlet. Also disclosed is a closing element for the check valve, which has a sealing cone, a contact foot with four outflow grooves formed on the edge, and an elastic sealing ring, which is designed as an O-ring, arranged between the contact foot and the sealing cone. The outflow grooves form in each case a seating edge for the elastic sealing ring during sealing. The sealing cone is entrained by the fluid flow and the sealing ring, designed as an O-ring, can be pressed into the check valve seat, designed as a hollow cone, even in the event of low system pressures. With increasing system pressure, the sealing cone is pressed harder into the valve seat and by means of the sealing element, designed as an O-ring, forms a seal and is retained in the valve seat still tighter with increasing pressure difference. In the opening direction, the sealing cone is located against an abutment as a result of fluid flow and the fluid can flow freely through the fluid passage and the outflow grooves. As a result of overloading, excessively large local stresses can arise on the sealing element in the region of the seating edges during sealing, as a result of which the service life of the sealing element can be shortened.

### SUMMARY

The check valve for a solenoid valve with the features of the disclosure has the advantage that with the same basic functionality increased demands with regard to the loadability and the leak-tightness can be additionally met throughout the service life.

By means of the new geometric design of the outflow grooves, embodiments of the check valve according to the disclosure for a solenoid valve advantageously reduce the local stresses which can arise as a result of an extrusion of the elastic sealing element into the outflow grooves during sealing. The optimized outflow grooves lead to longer seating edges during sealing. As a result of the longer seating edges, the local stresses in the event of an extrusion during sealing are reduced with constant force.

Embodiments of the present disclosure provide a check valve for a solenoid valve, which comprises a check valve seat, arranged on the edge of a fluid passage, and a movable closing element for executing a direction-oriented throughflow and sealing function. The closing element has a sealing cone, a contact foot with a plurality of outflow grooves formed on the edge, and an elastic sealing ring which is arranged between the contact foot and the sealing cone. The outflow grooves form in each case a seating edge for the elastic sealing ring during sealing. In this case, the outflow grooves are designed in each case with an arcuate seating edge, which has a predetermined arc length, so that a circle segment of the elastic sealing ring, with an opening angle in the region of 40° to 120°, butts against the respective seating edge during sealing.

Also proposed is a solenoid valve with a solenoid sub-assembly, a valve cartridge and a valve bottom part. Formed in this case between a fluid inlet and a fluid outlet is a first fluid passage, the flow cross section of which is adjustable by a main valve, and a second fluid passage, the flow cross section of which is adjustable by means of a direction-oriented check valve according to the disclosure.

As a result of the measures and developments quoted in the dependent claims, advantageous improvements of the check valve for a solenoid valve and of the solenoid valve are possible.

Particularly advantageous is the fact that the contact foot can have a circular base surface and two outflow grooves, wherein the two outflow grooves can be designed opposite each other on the periphery of the contact foot. Therefore, the seating edges can for example be of convex or concave design.

In an advantageous embodiment of the check valve, the outflow grooves can be designed as circle segments with a predetermined radius and a predetermined arc length. The radius and the arc length of the circle segments can be advantageously selected so that the ensuing outflow grooves have flat concave seating edges.

Alternatively, the outflow grooves can be designed as circle segments with a predetermined outside radius and a predetermined inside radius and a predetermined arc length. As a result of a suitable selection of the inside radius and the arc length of the circle segments, the ensuing recesses can have flat convex seating edges.

In a further advantageous embodiment of the check valve, the elastic sealing ring can be designed as an O-ring seal. Since O-ring seals are manufactured as mass-produced products an inexpensive manufacture of the closing elements is consequently made possible as a result.

In an advantageous embodiment of the solenoid valve, the check valve seat can be formed in the valve bottom part. Furthermore, the contact foot can butt against an abutment in the open state of the check valve. The abutment can for example form the valve bottom part and/or a flat filter which is inserted into the valve bottom part.

### BRIEF DESCRIPTION OF THE DRAWINGS

Exemplary embodiments of the disclosure are shown in the drawings and explained in more detail in the following description. In the drawings, the same designations refer to components or elements which perform the same or similar functions.

FIG. 1 shows a schematic partially sectioned view of an exemplary embodiment of a valve cartridge of a solenoid valve which has a check valve according to the disclosure.

FIG. 2 shows a schematic perspective view of a first exemplary embodiment of a closing element for the check valve according to the disclosure from FIG. 1.

FIG. 3 shows a schematic view of the closing element from FIG. 2 from the bottom.

FIG. 4 shows a schematic perspective view of a second exemplary embodiment of a closing element for the check valve according to the disclosure from FIG. 1.

FIG. 5 shows a schematic view of the closing element from FIG. 4 from the bottom.

### DETAILED DESCRIPTION

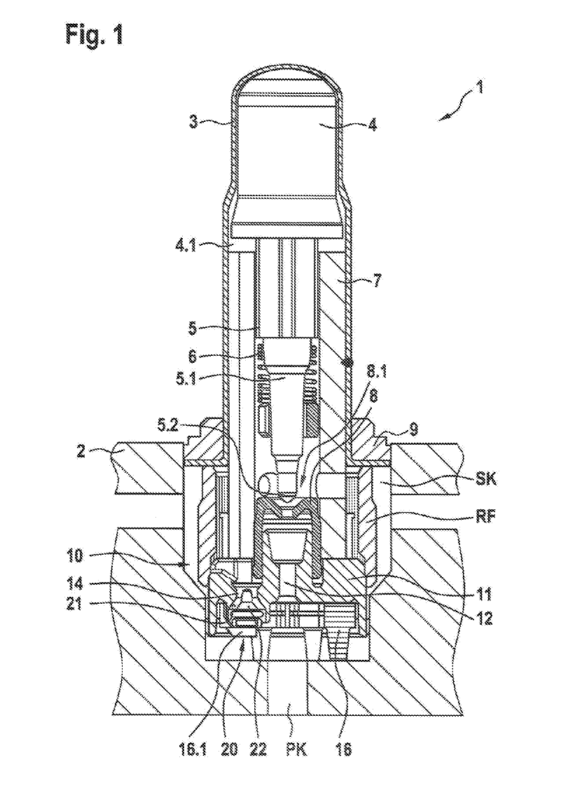

As is apparent from FIG. 1, the depicted exemplary embodiment of a valve cartridge 1 for a de-energized to open solenoid valve comprises a capsule 3, a valve insert 7, an armature 4 with a plunger 5, which features a closing body 5.1 and a main sealing element 5.2, and a return spring 6. A solenoid sub-assembly, which is not shown in more detail, creates a magnetic force which moves the longitudinally movable armature 4 with the plunger 5 against the force of the return spring 6 against the valve insert 7. Moreover, the valve insert 7 accommodates the valve body 8, which includes a main valve seat 8.1, into which the main sealing element 5.2 immerses with sealing effect in order to realize the sealing function of the solenoid valve. As is also apparent from FIG. 1, the depicted valve cartridge 1 comprises a check valve 20 according to the disclosure which executes a direction-oriented throughflow function.

As is also apparent from FIG. 1, the valve cartridge 1 is caulked in a fluid block 2 via a caulking plate 9 with a receiving hole and separates a primary circuit PK from a secondary circuit SK. Formed between the primary circuit PK or a fluid inlet and the secondary circuit SK or a fluid outlet, in a basic body 11 of the valve bottom part 11, are a first fluid passage 12, the flow cross section of which is adjustable by a main valve, and a second fluid passage 14, the flow cross section of which is adjustable by means of the direction-oriented check valve 20. As is also apparent from FIG. 1, the main sealing element 5.2 and the main valve seat 8.1 form the main valve.

As is also apparent from FIG. 1, the check valve 20 according to the disclosure in the depicted exemplary embodiment comprises a movable closing element 22, a check valve seat 21 which is arranged in the valve bottom part 10 on the edge of the second fluid passage 14 and a travel limiter or abutment 16.1 which limits the maximum travel of the movable closing element 22. In the depicted exemplary embodiment, the abutment 16.1 is designed as part of a flat filter 16 which is inserted into the valve bottom part 10 and closes this off toward the bottom. Moreover, a ring filter RF is seated on the valve bottom part 10. The valve bottom part 10, the flat filter 16 and the ring filter RF are produced as plastic injection molded parts in the depicted exemplary embodiment. The closing element 22 is entrained by the fluid flow and even in the event of low system pressures is pressed into the check valve seat 21, designed as a hollow cone, into a sealing state. In the opening direction, the closing element 22 is located against the abutment 16.1 by the fluid flow and the fluid can flow through the second fluid passage 14.

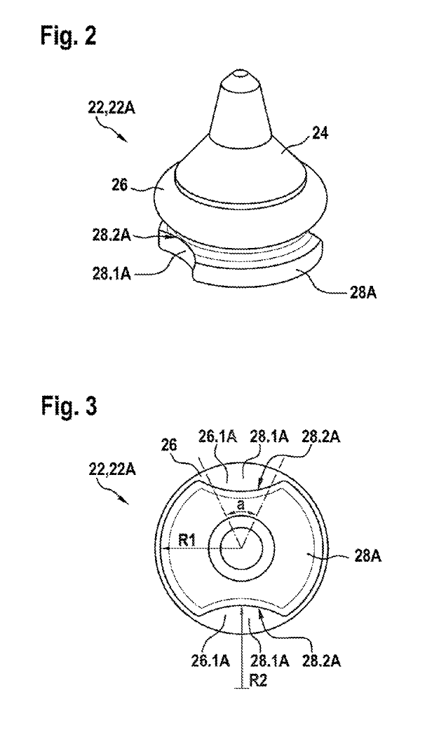

As is apparent from FIGS. 2 to 5, the depicted exemplary embodiments of the movable closing element 22, 22A, 22B for executing the direction-oriented throughflow and sealing function of the check valve 20 according to the disclosure comprise in each case a sealing cone 24, a contact foot 28A, 28B with a plurality of outflow grooves 28.1A, 28.1B formed on the edge, and an elastic sealing ring 26 which is arranged between the contact foot 28A, 28B and the sealing cone 24. The outflow grooves 28.1A, 28.1B form in each case a seating edge 28.2A, 28.2B for the elastic sealing ring 26 during sealing. In this case, the outflow grooves 28.1A, 28.1B are designed in each case with an arcuate seating edge 28.2A, 28.2B, which has a predetermined arc length, so that a circle segment 26.1A, 26.1B of the elastic sealing ring 26, with an opening angle a in the region of 40° to 120°, butts against the respective seating edge 28.2A, 28.2B during sealing.

As is also apparent from FIGS. 2 to 5, the contact foot 28A, 28B has a circular base surface with a first radius R1 and two outflow grooves 28.1, 28.2 which are formed opposite each other on the periphery of the contact foot 28A, 28B. The elastic sealing ring 26 is designed in each case as an O-ring seal in the depicted exemplary embodiments.

As is also apparent from FIGS. 2 and 3, the two outflow grooves 28.1A in the depicted exemplary embodiment are designed as circle segments with a predetermined radius R2 and a predetermined arc length. As is also apparent from FIGS. 2 and 3, the radius R2 and the arc length of the circle segments are selected so that the ensuing outflow grooves 28.1A have flat concave seating edges 28.2A. As a result, two first circle segments 26.1A of the elastic sealing ring 26, with an opening angle a in the region of about 40° to 80°, in each case butts against the respective seating edge 28.2A during sealing. As a result of the longer seating edges 28.2A in comparison to the prior art, the local stresses in the event of an extrusion of the elastic sealing ring 26 into the outflow grooves 28.1A are reduced during sealing with constant force.

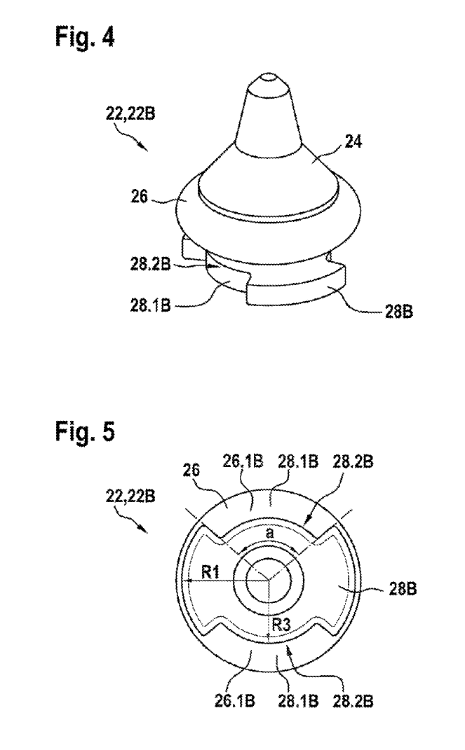

As is also apparent from FIGS. 4 and 5, the two outflow grooves 28.1B in the depicted exemplary embodiment are designed as circle segments with a predetermined outside radius R1 and a predetermined inside radius R3 and a predetermined arc length. As is also apparent from FIGS. 4 and 5, the outside radius R1 corresponds to the first radius R1 of the base surface of the contact foot 28B. The inside radius R3 and the arc length of the circle segments are selected so that the ensuing outflow grooves 28.1B have flat convex seating edges 28.2B. As a result, two second circle segments 26.1B of the elastic sealing ring 26, with an opening angle a in the region of about 80° to 120°, in each case butt against the respective seating edges 28.2B. As a result of the longer seating edges 28.2B in comparison to the prior art, the local stresses during an extrusion of the elastic sealing ring 26 into the outflow grooves 28.1B are reduced in a similar way to the first exemplary embodiment during sealing with constant force.

As a result of the new geometric design of the outflow grooves, embodiments of the check valve according to the disclosure for a solenoid valve advantageously reduce the local stresses which can arise as a result of an extrusion of the elastic sealing element into the outflow grooves.

What is claimed is:

1. A check valve for a solenoid valve, comprising:
a check valve seat arranged on an edge of a fluid passage; and
a movable closing element configured to execute a direction-oriented throughflow and sealing function,
wherein the closing element has a sealing cone, a contact foot with a plurality of outflow grooves formed on the edge, and an elastic sealing ring arranged between the contact foot and the sealing cone, and
wherein the outflow grooves (i) form in each case a seating edge for the elastic sealing ring during sealing and (ii) are configured in each case with an arcuate seating edge, which has a predetermined arc length, so that a circle segment of the elastic sealing ring, with an opening angle in the region of 40° to 120°, butts against the respective seating edge during sealing.

2. The check valve according to claim 1, wherein the contact foot has a circular base surface and two outflow grooves, and wherein the two outflow grooves are formed opposite each other on the periphery of the contact foot.

3. The check valve according to claim 1, wherein the seating edges are of convex or concave configuration.

4. The check valve according to claim 1, wherein the outflow grooves are configured as circle segments with a predetermined radius and a predetermined arc length.

5. The check valve according to claim 1, wherein the outflow grooves are configured as circle segments with a predetermined outside radius, a predetermined inside radius, and a predetermined arc length.

6. The check valve according to claim 1, wherein the elastic sealing ring is configured as an O-ring seal.

7. A solenoid valve, comprising:
a solenoid sub-assembly;
a valve cartridge; and
a valve bottom part,
wherein a first fluid passage is formed between a fluid inlet and a fluid outlet, the first fluid passage having a flow cross section that is adjustable by a main valve, and
wherein a second fluid passage has a flow cross section that is adjustable by a direction-oriented check valve, the check valve including:
a check valve seat arranged on an edge of a fluid passage, and
a movable closing element configured to execute a direction-oriented throughflow and sealing function,
wherein the closing element has a sealing cone, a contact foot with a plurality of outflow grooves formed on the edge, and an elastic sealing ring arranged between the contact foot and the sealing cone, and
wherein the outflow grooves (i) form in each case a seating edge for the elastic sealing ring during sealing and (ii) are configured in each case with an arcuate seating edge, which has a predetermined arc length, so that a circle segment of the elastic sealing ring, with an opening angle in the region of 40° to 120°, butts against the respective seating edge during sealing.

8. The solenoid valve according to claim 7, wherein the check valve seat is formed in the valve bottom part.

9. The solenoid valve according to claim 7, wherein the contact foot butts against an abutment in the open state of the check valve.

10. The solenoid valve according to claim 9, wherein one or more of the valve bottom part and a flat filter that is inserted into the valve bottom part form the abutment.
